(19) United States
(12) Patent Application Publication
(10) Pub. No.: US 2002/0141729 A1
(43) Pub. Date: Oct. 3, 2002

(54) Fiber optic calibration fixture and method

(75) Inventor: Michael P. Oliver, Beavercreek, OH (US)

Correspondence Address: DELPHI TECHNOLOGIES, INC., 1450 W. Long Lake, P. O. Box 5052, Mail Code: 482-204-450, Troy, MI, 48098, US

(73) Assignee: DELPHI TECHNOLOGIES INC.

(21) Appl. No.: 09/822,916

(22) Filed: Mar. 30, 2001

(51) Int. Cl. G02B 6/00; G01C 1/00; G01B 11/16

(52) U.S. Cl. 385/147; 356/32

(57) ABSTRACT

A method and fixture is provided for calibrating an instrumented fastener. The fixture includes an upper member. A cap member of the fixture can be removably attached to the upper member. The cap member can include an opening formed therein to receive an upper portion of the fastener. A lower member can be positioned adjacent the cap member, the lower member including an opening formed therein. A removable insert can be positioned in the lower member opening to receive a lower portion of the fastener.

### TECHNICAL FIELD

The present invention is related to instrumented fasteners. In particular, the present invention is related to a fixture and method for calibrating instrumented fasteners.

### BACKGROUND OF THE INVENTION

The use of threaded fasteners to connect materials together is well known. As used herein, threaded fasteners include nuts and bolts, bolts received in tapped holes, studs, and the like. The fasteners and the elements that are fastened together are collectively termed a joint.

Compression of the joint and the tension along the shank of the threaded fastener affect the quality of the joint. When assessing joint properties, fastener creep and other joint-specific qualities, it is necessary to ascertain joint strain or clamp-load. However, fastener tension is difficult to measure directly. Typically, fastener tension has been deduced from measurements of fastener torque, because this measurement is easily taken during assembly of the joint. However, the relationship between fastener torque and tension is dependent on a number of variables including the coefficient of friction between the fastener and the elements to be connected. Even identical fasteners can produce significantly different joint loads when driven to same torque levels. Instead of relying or torque or the like, load washers, certain ultrasonic techniques and instrumented bolts have all been used to provide more direct indications of fastener tension.

The uses of fiber optic sensors are also well known in the art, which are useful for detecting vibration, pressure, strain and other forces. When used in conjunction with a fastener, the combination of the fiber optic sensor and the fastener is referred to as an instrumented fastener. The instrumentation uses fiber optic technology to determine the amount of strain, and hence clamp load in a joint. This information is useful when evaluating fastener performance and joint performance in different assembled systems, for example.

In order for this instrumentation to provide consistent data, each fastener including instrumentation should be accurately calibrated.

### SUMMARY OF THE INVENTION

One aspect of the present invention provides a fixture for calibrating an instrumented fastener including an upper member. A cap member can be removably attached to the upper member. The cap member can include an opening formed therein to receive an upper portion of the fastener. A lower member can be positioned adjacent the cap member, the lower member including an opening formed therein. A removable insert can be positioned in the lower member opening to receive a lower portion of the fastener.

Other aspects of the present invention provide a cap that includes a joint specific spacer section to provide a predetermined position of the fastener within the fixture. The upper member can include a threaded extension for threaded attachment to the cap member. The upper member can include a chamber formed therein for receiving the upper portion of the fastener. The upper member can further include a port formed therein, the port allowing cable access to the upper member chamber. The cap member opening can be a threaded opening, or and unthreaded opening. The lower member opening can be a threaded opening. The lower member can further include a chamber formed therein. The lower member can further include a port formed therein, the port allowing cable access to the lower member chamber. The removable insert can include a threaded outer portion for threaded engagement with the lower member opening. The removable insert can include a threaded opening, the threaded opening including a configuration adapted to threadably engage the lower portion of the fastener. The removable insert can be one of a plurality of removable inserts, each of which including a threaded opening adapted to threadably engage a fastener with a different engaging configuration.

The upper member and the cap member can comprise an upper section. The lower member and the removable insert can comprise a lower section. The upper section and the lower section can each include an attachment portion.

Another aspect of the present invention provides a method of calibrating an instrumented fastener including positioning a fiber-optic sensor within a fastener. A removable insert member is positioned within a lower member of a calibration fixture. A cap member is positioned adjacent to the removable insert member. The fastener is inserted through an opening in the cap member. A lower threaded portion of the fastener is screwed into the threaded insert member. The cap member is attached to an upper section of the calibration fixture. The fiber optic sensor is operably connected to a measuring device. A predetermined tensile force is applied to the fastener and recording a measurement from the fiber-optic sensor.

Other aspects of the method of the present invention provide a predetermined tensile force being applied to the fastener by applying a tensile force to the upper and lower members of the calibration fixture.

Another aspect of the present invention provides a system for calibrating an instrumented fastener including a means for positioning a fiber-optic sensor within a fastener, a means for positioning a removable insert member within a lower section of a calibration fixture, means for positioning a cap member adjacent to the removable insert member, means for inserting the fastener through the cap member, means for securing a lower threaded portion of the fastener within the threaded insert member, means for attaching the cap member to an upper section of the calibration fixture, means for operably connecting the fiber-optic sensor to a measuring device, means for applying a predetermined tensile force to the fastener and means for recording a measurement from the fiber-optic sensor.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustration of an embodiment of the fixture of the present invention; and

FIG. 2 is an illustration of another embodiment of the system of the present invention.

### DESCRIPTION OF THE PREFERRED EMBODIMENTS

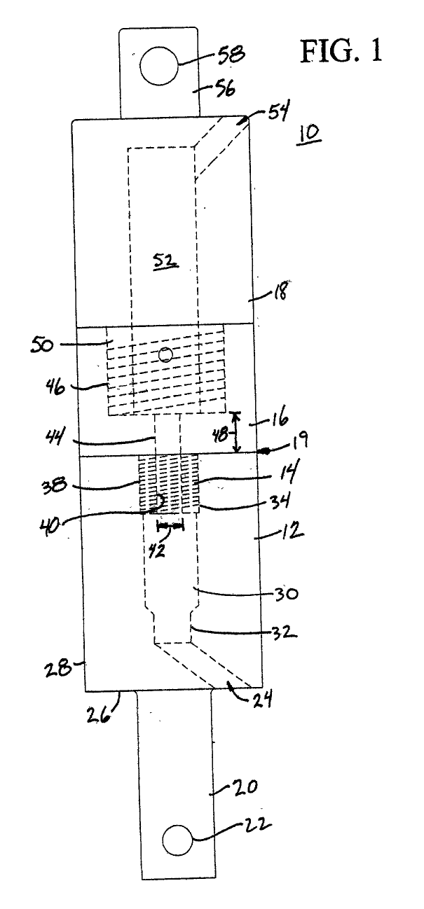

Referring to FIG. 1, one embodiment of the calibration fixture of the present invention is shown generally at 10. The fixture for calibration of a fastener or other coupling device including a strain gauge or fiber-optic instrument generally comprises a lower section 12, a threaded insert 14, an end cap 16 and an upper section 18.

In the embodiment shown in FIG. 1, the lower section 12 and the insert 14 can be fastened together. The end cap 16 and the upper section 18 can be fastened together. When positioned adjacent each other the lower assembly 12, 14 and the upper assembly 16, 18 define a joint therebetween. An instrumented fastener can be provided, which holds the lower assembly 12, 14 to the upper assembly 16, 18.

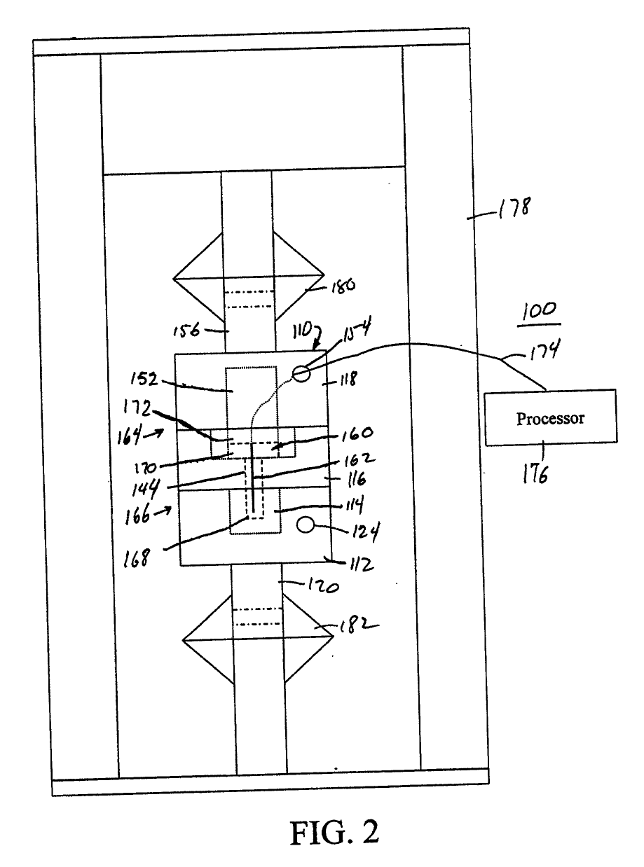

As will be described and shown more fully herein, a predetermined tensile force is applied to the upper and lower assemblies 16, 18; 12, 14 (by, for example, a testing device manufactured by Instron Corporation, and shown generally at FIG. 2). The tensile force stretches the fastener (not shown) across the joint 19. An instrument in the fastener detects the amount of strain in the fastener and an associated processor assigns a value corresponding to the amount of strain detected by the. The instrument can be, for example, a fiber-optic sensor. The value represents the amount of strain in the fastener at the predetermined tensile force.

The lower member or section 12 of the fixture 10 can include a lower extending portion 20. The lower extending portion 20 can include a lower attachment hole 22, which, as shown in the illustrated embodiment, can be a perpendicular hole formed through the lower extending portion 20. The lower section 12 can include a lower port 24 for cable access therethrough, or the like. The lower port 24 can be an opening in the body of the lower section 12 that can exit at an end 26 or a sidewall 28, for example, of the lower section 12. The lower port 24 can communicate with an inner chamber 30. The inner chamber 30 can be formed as an axial chamber, which communicates with the lower port 24 at a first end 32, and can include a threaded portion 34 at a second end thereof.

A threaded insert 14 can be removably attachable to the threaded portion 34 of the lower section 12. The insert 14 can be provided with outer threads 38 to engage the threaded portion 34 of the lower section 12. Each insert 14 designed for different fasteners can be provided a same outer thread pitch, for example, a 1:14 external thread pitch for engagement with the threaded portion 34 and consistent calibration results. An internal threaded bore 40 can be formed in the threaded insert 14. It will be understood that the configuration or specifications of the internal threaded bore 40 will be fastener specific. In other words, the diameter and thread pitch of the bore 40 will be formed according to the specifications of the fastener to be calibrated. Thus, the specifications of the inner diameter 42 of the bore of the internal thread 40 will differ when calibrating a fastener with a major diameter of 8 mm as compared to a 6 mm fastener, or a fastener having 14 threads per inch (TPI) compared to a fastener having 16 TPI. The bore 40 can be open at both ends so that a fastener (not shown) can be inserted therethrough. The insert 14 can be designed to receive an entire or a portion of the threaded length of the intended fastener. From the figure, it can be seen that the insert 14 can thread into the lower section 12 such that a flat surface (at 19) can be provided.

The end cap 16 contacts the flat surface provided by the lower section 12 and insert 14 to define joint 19. The end cap 16 includes an opening 44 with a first diameter 42 to receive a portion of the length of the fastener, and a second diameter 46 to receive the head portion of the fastener, in the event that the fastener is a screw or bolt. If a stud, or like coupler, is being calibrated, the opening 44 may be threaded. However, when calibrating fasteners with some length having no threads formed thereon, (i.e., a portion of the length of the fastener adjacent the head) the opening 44 may be unthreaded.

The thickness 48 of the end cap 16 can be provided at a specified or predetermined thickness. The specified thickness can be made equal to the thickness of the element that will be held by the fastener when the fastener is applied to the joint to be tested. For example, if a one-inch plate is to be fastened to a block by a fastener calibrated by the present invention, the predetermined thickness 48 of the cap 16 can be specified at one inch. Whereas some fasteners may be calibrated only by reproducing the configuration of the joint precisely, some fasteners may be accurately calibrated using configurations that are not exact duplications of the joint dimensions.

The second diameter of the opening 46 can be provided with threads to permit a threaded connection between the end cap 16 and a threaded extension 50 of the upper section 18. The upper section 18 can include a chamber 52, which can extend axially. An upper port 54 can be formed through the upper section 18 to allow a cable or the like to pass from the chamber 52 and out of the upper section 18. An extension 56 can be provided with an opening 58 to permit attachment of the upper section or member 18 to an external device.

Referring to FIG. 2, another embodiment of present invention is illustrated generally at 100. A fastener 160 to be calibrated is shown in phantom. It should be understood that the fastener 160 to be calibrated could be a bolt, screw, stud, rod, or the like. A strain gauge 162, which can be a fiber-optic sensor, can be positioned in the fastener 160.

A fixture 110 can include an upper assembly, or section 164, and a lower assembly or section 166. The lower assembly 166 can include a threaded insert member 114 that is secured within a lower member 112 of the fixture to hold the fastener 160 at a lower portion 168. A cup member 116 that is secured to an upper member 118 of the fixture 110 can be positioned to hold an upper portion 170 of the fastener 160, which in this case, is the head of a bolt, or the like. An opening 172 in the cup member 116 can receive the head of the bolt, the opening 172 forming a chamber with an opening 152 in the upper member 118. An upper port 154 and a lower port 124 can be formed in the upper member 118 and the lower member 112 respectively to permit a cable 174, or the like, to exit the fixture 110 and connect in an operative fashion to a processor 176.

The upper and lower members 118, 112 can include a fastener portion or attachment portion 156, 120. It will be understood that the configuration of the attachment portions 156, 120 will be adapted to secure the fixture 110 to a force-applying device 178 designed to apply a tensile force to the fixture 110. Thus, the force-applying device 178 will include upper and lower clamps 180, 182, or the like, which attach to the attachment portions 156, 120 in a secure fashion. Since the tensile forces to be applied to the instrumented fastener 160 can be quite high it will be understood that the fixture 160, attachment portions 156, 120, clamps 180, 182 and force-applying device 178 will be of a robust nature.

In one embodiment, as is known in the art, a signal is sent through the cable 174 and can reflect off of a surface or portion of the sensor 162 positioned within the fastener 160. The signal can reflect off of the sensor surface, and returns to the processor 176. The time it takes for the signal to travel through of the cable 174, reflect off the sensor surface and return to the processor corresponds to the distance the signal must travel. As the fastener 160 is stretched during application of the tensile force thereto the signal takes a longer time to travel to and return from the surface. A correspondingly different value is assigned to the longer time interval.

In operation, to prepare the instrumented fastener 160, a fiber-optic sensor 162 is positioned and secured within a fastener. In one embodiment, the sensor 162 can be secured within the fastener 160 by using epoxy. The sensor 162 can include an end mirror surface that reflects light.

The assembly of the fixture 110 can begin by positioning the removable insert member 114 within a lower member 112 of the calibration fixture. A cap member 116 can be positioned adjacent to the removable insert member 114. The fastener 160 including the sensor 162 can be inserted through an opening 144 in the cap member 116, and screwed into a threaded portion or bore of the insert member 114. An upper section 118 of the calibration fixture 110 can be attached to the cap member 116. The fiber-optic sensor 162 can be operably connected to a measuring device 176. As discussed previously, the device can be a processor, which generates a signal and measures the time interval the signal travels. The predetermined tensile force is applied to the fastener 160. The processor 176 records the signal from the sensor 162.

The processor 176 can assign a value to the recorded signal, which in one embodiment is a voltage. For example, if a tensioned instrumented fastener 160 generates a two volt signal when tensioned at 20 Kilonewtons (kN) in the calibration fixture 110, it will be understood that when the same fastener is used in a joint to be tested, or the like, that the two volt signal generated by the fastener 160 will correspond to a clamping force in the joint of 20 kN.

With each different fastener 160 to be calibrated in this manner, only a new threaded insert member 114 and, in some instances, a cap member 116 need to be manufactured. Accordingly, consistent calibration of different fasteners is ensured.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

1. A fixture for calibrating an instrumented fastener comprising:
an upper member;
a cap member removably attached to the upper member, the cap member including an opening formed therein to receive an upper portion of the fastener;
a lower member positioned adjacent the cap member, the lower member including an opening formed therein;
a removable insert positioned in the lower member opening to receive a lower portion of the fastener.

2. The fixture of claim 1 wherein the cap includes a joint specific spacer section to provide a predetermined position of the fastener within the fixture.

3. The fixture of claim 1 wherein the upper member includes a threaded extension for threaded attachment to the cap member.

4. The fixture of claim 3 wherein the upper member includes a chamber formed therein for receiving the upper portion of the fastener.

5. The fixture of claim 4 wherein the upper member further includes a port formed therein, the port allowing cable access to the upper member chamber.

6. The fixture of claim 1 wherein the cap member opening is a threaded opening.

7. The fixture of claim 1 wherein the cap member opening is an unthreaded opening.

8. The fixture of claim 1 wherein the lower member opening is a threaded opening.

9. The fixture of claim 1 wherein the lower member further includes a chamber formed therein.

10. The fixture of claim 1 wherein the lower member further includes a port formed therein, the port allowing cable access to the lower member chamber.

11. The fixture of claim 8 wherein the removable insert includes a threaded outer portion for threaded engagement with the lower member opening.

12. The fixture of claim 11 wherein the removable insert includes a threaded opening, the threaded opening including a configuration adapted to threadably engage the lower portion of the fastener.

13. The fixture of claim 12 wherein the removable insert is one of a plurality of removable inserts, each of which include a threaded opening adapted to threadably engage a fastener with a different engaging configuration.

14. The fixture of claim 1 wherein the upper member and the cap member comprise an upper section.

15. The fixture of claim 14 wherein the lower member and the removable insert comprise a lower section.

16. The fixture of claim 15 wherein the upper section and the lower section each include an attachment portion.

17. A method comprising:
positioning a fiber-optic sensor within a fastener;
positioning a removable insert member within a lower member of a calibration fixture;
positioning a cap member adjacent to the removable insert member;
inserting the fastener through an opening in the cap member;
screwing a lower threaded portion of the fastener into the threaded insert member;
attaching the cap member to an upper section of the calibration fixture;
operably connecting the fiber-optic sensor to a measuring device;
applying a predetermined tensile force to the fastener; and
recording a measurement from the fiber-optic sensor.

18. The method of claim 17 wherein the predetermined tensile force is applied to the fastener by applying a tensile force to the upper and lower members of the calibration fixture.

19. A system for calibrating an instrumented fastener comprising:
means for positioning a fiber-optic sensor within a fastener;
means for positioning a removable insert member within a lower section of a calibration fixture;
means for positioning a cap member adjacent to the removable insert member;
means for inserting the fastener through the cap member;
means for securing a lower threaded portion of the fastener within the threaded insert member;
means for attaching the cap member to an upper section of the calibration fixture;
means for operably connecting the fiber-optic sensor to a measuring device;
means for applying a predetermined tensile force to the fastener; and
means for recording a measurement from the fiber-optic sensor.

20. A system for calibrating an instrumented fastener comprising:
an upper assembly adapted to receive an upper portion of the fastener;
a lower assembly adapted to receive a lower portion of the fastener; and
means for attaching the upper and lower assemblies to a tension-producing device, wherein the application of a predetermined tensile force by the tension-producing device across the upper and lower assemblies produces a strain in the fastener detectable by the instrument.
